(19) United States
(12) Patent Application Publication
(10) Pub. No.: US 2022/0281286 A1
(43) Pub. Date: Sep. 8, 2022

(54) HEATING AND COOLING SYSTEMS AND METHODS FOR TRUCK CABS

(71) Applicant: Tiger Tool International Incorporated, Abbotsford, CA (US)

(72) Inventor: Michael Andrews, Bellingham, WA (US)

(73) Assignee: Tiger Tool International Incorporated, Abbotsford (CA)

(21) Appl. No.: 17/664,935

(22) Filed: May 25, 2022

Related U.S. Application Data
(63) Continuation of application No. 16/075,804, filed on Aug. 6, 2018.
(60) Provisional application No. 62/336,497, filed on May 13, 2016.

(51) Int. Cl. B60H 1/00; B60H 1/32; F25B 27/00; F25B 41/22

(52) U.S. Cl. CPC B60H 1/00428; B60H 1/00378; B60H 1/0045; B60H 1/3222; F25B 27/00; B60H 1/3223; F25B 41/22; Y02T 10/88

(57) ABSTRACT

A vehicle heating and cooling system has a vehicle evaporator coil, a vehicle HVAC user interface, a compressor, a compressor coil, and a controller. The controller is connected between the vehicle HVAC user interface and the compressor. The compressor and compressor coil are connected to the vehicle evaporator coil.

### RELATED APPLICATIONS

This application (Attorney's Ref. No. P220271) is a continuation of U.S. patent application Ser. No. 16/075,804 filed Aug. 6, 2018, currently pending.

U.S. Patent Application Serial No. 16/075,804 filed Aug. 6, 2018 is a 371 of International PCT Application No. PCT/US2017/032750 filed May 15, 2017, now expired.

International PCT Application No. PCT/US2017/032750 claims benefit of U.S. Provisional Application Ser. No. 62/336,497 filed May 13, 2016, now expired.

The contents of all related applications are incorporated herein by reference.

### TECHNICAL FIELD

The present invention relates to systems and methods for heating and cooling the interior of a vehicle and, more particularly, to vehicle heating and cooling systems and methods that employ a heat pump.

### BACKGROUND

Utility power is typically made available as an AC power signal distributed from one or more centralized sources to end users over a power distribution network. However, utility power is unavailable for certain structures. For example, movable structures such as vehicles do not have access to utility power when moving and can be connected to power distribution network when parked only with difficulty. Similarly, remote structures such as cabins and military installations not near the utility power distribution network often cannot be practically powered using utility power.

DC power systems including batteries are often employed to provide power when utility power is unavailable. For example, trucks and boats typically employ a DC power system including a battery array to provide power at least to secondary vehicle electronics systems such as communications systems, navigation systems, ignition systems, heating and cooling systems, and the like. Shipping containers and remote cabins that operate using alternative primary power sources such as solar panels or generators also may include DC power systems including a battery or array of batteries to operate electronics systems when primary power is unavailable. Accordingly, most modern vehicles and remote structures use battery power sufficient to operate, at least for a limited period of time, electronics systems such as secondary vehicle electronics systems.

The capacity of a battery system used by a vehicle or remote structure is typically limited by factors such as size, weight, and cost. For example, a vehicle with an internal combustion engine may include a relatively small battery for use when the engine is not operating; a large battery array is impractical for vehicles with an internal combustion engine because the size of the batteries takes up valuable space and the weight of the batteries reduces vehicle efficiency when the vehicle is being moved by the engine. All electric vehicles have significantly greater battery capacity, but that battery capacity is often considered essential for the primary purpose of moving the vehicle, so the amount of battery capacity that can be dedicated to secondary vehicle electronics systems is limited. Battery systems employed by remote structures must be capable of providing power when the alternative power source is unavailable, but factors such as cost, size, and weight reduce the overall power storage capacity of such systems.

Heating and cooling systems have substantial energy requirements. Vehicles such as trucks or boats typically rely on the availability of the internal combustion engine when heating or cooling is required. The present invention is of primary significance in the context of a vehicle having an internal combustion engine.

When heating or cooling is required when the vehicle is parked or the boat is moored for more than a couple of minutes, the internal combustion engine will be operated in an idle mode solely to provide power to the heating and cooling system. Engine idling is inefficient and creates unnecessary pollution, and anti-idling laws are being enacted to prevent the use of idling engines, especially in congested environments like cities, truck stops, and harbors. For remote structures such as cabins or shipping containers, heating and cooling systems can be a major draw on battery power. Typically, an alternative or inferior heating or cooling source such as a wood burning stove, fans, or the like are used instead of a DC powered heating and cooling system.

The need thus exists for auxiliary heating and cooling systems that use battery power in vehicles having internal combustion engines.

### SUMMARY

The present invention may be embodied as a vehicle heating and cooling system having a vehicle evaporator coil, a vehicle HVAC user interface, a compressor, a compressor coil and a controller. The controller is connected between the vehicle HVAC user interface and the compressor. The compressor and compressor coil are connected to the vehicle evaporator coil.

The present invention may also be embodied as a method of heating and cooling a vehicle comprising the following steps. A controller is connected between a vehicle HVAC user interface and a compressor. The compressor and compressor coil are connected to the vehicle evaporator coil.

The present invention may also be embodied as a heating and cooling system for a vehicle comprising an internal combustion engine. The heating and cooling system of the present invention comprises a vehicle battery, a vehicle evaporator coil, a vehicle HVAC user interface, an auxiliary battery, a compressor, a compressor coil, a vehicle charging system, and a control system. The vehicle charging system is operatively connected to the internal combustion engine. The control system is configured to operatively connect at least one of the vehicle battery, the auxiliary battery, and the vehicle charging system to the compressor. The compressor and compressor coil are connected to the vehicle evaporator coil. The compressor is not mechanically connected to the vehicle internal combustion engine.

### BRIEF DESCRIPTION OF THE DRAWINGS

FIG. 1 is a schematic view of a first example vehicle heating and cooling system of the present invention; and

FIG. 2 is a schematic view of a second example vehicle heating and cooling system of the present invention.

### DETAILED DESCRIPTION

The present invention may be embodied in a number of different example configurations, and several examples of vehicle heating and cooling systems constructed in accordance with, and embodying, the principles of the present invention will be described separately below.

### I. First Example Auxiliary Heating and Cooling System

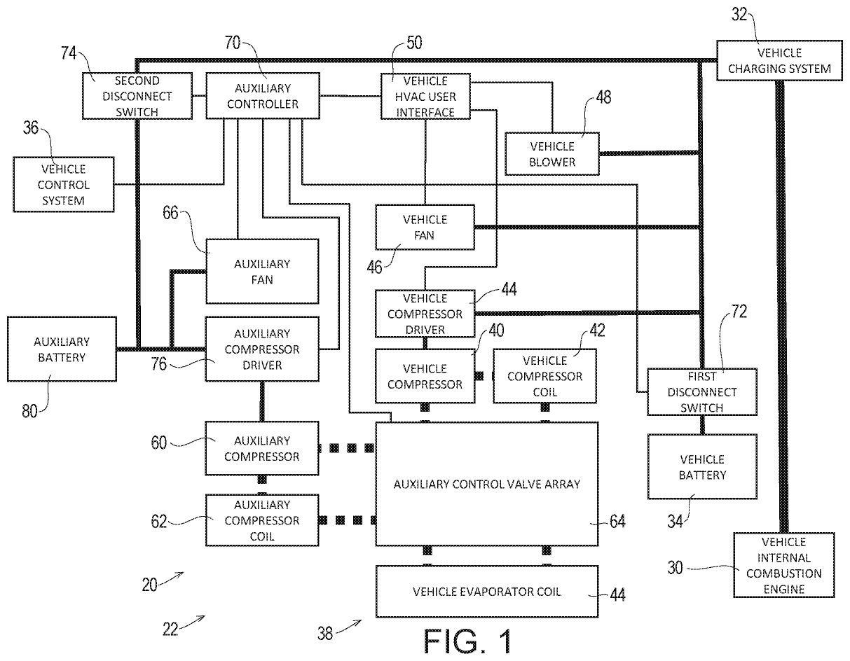

Referring initially to FIG. 1 of the drawing, depicted therein is a first example auxiliary vehicle heating and cooling system 20 of the present invention. As will be described in further detail below, the first example auxiliary vehicle heating and cooling system 20 is intended to augment a factory vehicle heating and cooling system.

The first example auxiliary vehicle heating and cooling system 20 is configured to be used in conjunction with a vehicle 22. In this application, the term “vehicle” refers to a movable structure (whether moving or stationary) having an internal combustion engine that drives an alternator to provide DC power to an on board electronics systems. Examples of vehicles include trucks, automobiles, shipping containers, and boats.

The example vehicle 22 is or may be conventional and comprises an internal combustion engine 30, a vehicle charging system 32, a vehicle battery 34, a vehicle control system 36, and a vehicle HVAC system 38. The example internal combustion system 30, vehicle charging system 32, vehicle battery 34, and vehicle control system 36 are or may be conventional and will not be described herein beyond what is helpful for a complete understanding of the present invention.

The example vehicle HVAC system 38 comprises a vehicle compressor 40, a vehicle compressor coil 42, and a vehicle evaporator coil 44 that may be configured to form a heat pump. The term “compressor coil” is used herein to refer to the condenser coil of a heat pump system as described herein, and the terms “condenser coil” and “compressor coil” may be used interchangeably in the present application. The vehicle compressor coil 42 is arranged to exchange heat with ambient air outside of the AC region to be heated or cooled (e.g, cabin or sleeper unit), and a vehicle fan 46 is associated with the example vehicle compressor coil 42. The vehicle evaporator coil 44 is arranged to exchange heat with air within the AC region, and a vehicle blower 48 is associated with the vehicle evaporator coil 44.

The example vehicle HVAC system 38 further comprises a vehicle HVAC user interface 50 arranged to allow an occupant of the AC region to control the vehicle HVAC system 38. The example HVAC user interface 50 may be implemented using mechanical or electromechanical interface objects such as switches, buttons, sliders, or the like and/or by electronic interface objects such as switches, buttons, touch screens, or the like. The example HVAC user interface system 50 may be implemented with or without a thermostat capable of detecting temperature within the AC region and controlling operation of the various components of the vehicle HVAC system 38 to maintain temperature within the AC region based on a desired temperature. Optionally, a vehicle compressor driver 52 may be used to facilitate operation of the vehicle compressor 40 by the vehicle HVAC user interface.

The first example auxiliary HVAC system 20 is configured to integrate with at least a portion of the vehicle HVAC system 38 and comprises an auxiliary compressor 60, an auxiliary compressor coil 62, and an auxiliary control valve array 64. The auxiliary control valve array 64 may be configured to connect the auxiliary compressor 60 and an auxiliary compressor coil 62 to the vehicle evaporator coil 44 to form a heat pump. The auxiliary compressor coil 62 is arranged to exchange heat with ambient air outside of the AC region, and an auxiliary fan 66 is associated with the example auxiliary compressor coil 62.

The example auxiliary HVAC system 20 further comprises an auxiliary controller 70, a first disconnect switch 72, and a second disconnect switch 74. The example auxiliary controller 70 is arranged to control the components of the auxiliary HVAC system 20 based on control settings of the vehicle HVAC user interface 50. Optionally, an auxiliary compressor driver 76 may be used to facilitate operation of the auxiliary compressor 60 by the auxiliary controller 70.

The example auxiliary HVAC system 20 further comprises an auxiliary battery system 80 comprising one or more batteries and associated circuitry and wiring.

The example auxiliary HVAC system 20 operates in at least one of a vehicle mode and an auxiliary mode as determined by the vehicle control system 36.

In the vehicle mode, the first disconnect switch 72 is closed to allow power to flow from the vehicle battery 34 to the vehicle compressor 40, vehicle fan 46, and vehicle blower 48. In the vehicle mode, the auxiliary control valve array 64 is configured to connect the vehicle compressor 40 and vehicle compressor coil 42 to the vehicle evaporator coil 44 and disconnect the auxiliary compressor 60 and auxiliary compressor coil 62 from the vehicle evaporator coil 44. The AC region is heated and cooled using the vehicle HVAC system 38 in the vehicle mode. The second disconnect switch 74 is closed to allow the vehicle charging system 32 to charge the auxiliary battery 80. In the vehicle mode, the vehicle HVAC user interface 50 controls the vehicle compressor 40 through the vehicle compressor driver 52, the vehicle fan 46, and the vehicle blower 48.

In the auxiliary mode, the first disconnect switch 72 is opened to prevent power from flowing from the vehicle battery 34 to the auxiliary HVAC system 20. When the HVAC system 20 is in the auxiliary mode, the auxiliary control valve array 64 is arranged to disconnect the vehicle compressor 40 and vehicle compressor coil 42 from the vehicle evaporator coil 44 and connect the auxiliary compressor 60 and auxiliary compressor coil 62 to the vehicle evaporator coil 44. The AC region is heated and cooled using the auxiliary HVAC system 20 in the auxiliary mode. The second disconnect switch 74 is opened to disconnect the auxiliary battery 80 from the vehicle charging system 32 and vehicle battery 34 to prevent draining of the vehicle battery 34 in the auxiliary mode.

In the auxiliary mode, the auxiliary controller 70 controls the auxiliary compressor 60 through the auxiliary compressor driver 76, and the auxiliary fan 66 based on user inputs to the vehicle HVAC user interface 50. The auxiliary controller 70 converts signals generated by the HVAC user interface 50 into control signals appropriate for the components of the auxiliary HVAC system 20. The auxiliary controller 70 may further comprise an on/off switch accessible by the user and one or more of a temperature sensor and a pressure sensor capable of sensing temperatures (e.g., temperature of AC region) and pressures (e.g., pressure within auxiliary HVAC system 20) necessary to ensure proper operation of the auxiliary HVAC system 20.

### II. Second Example Auxiliary Heating and Cooling System

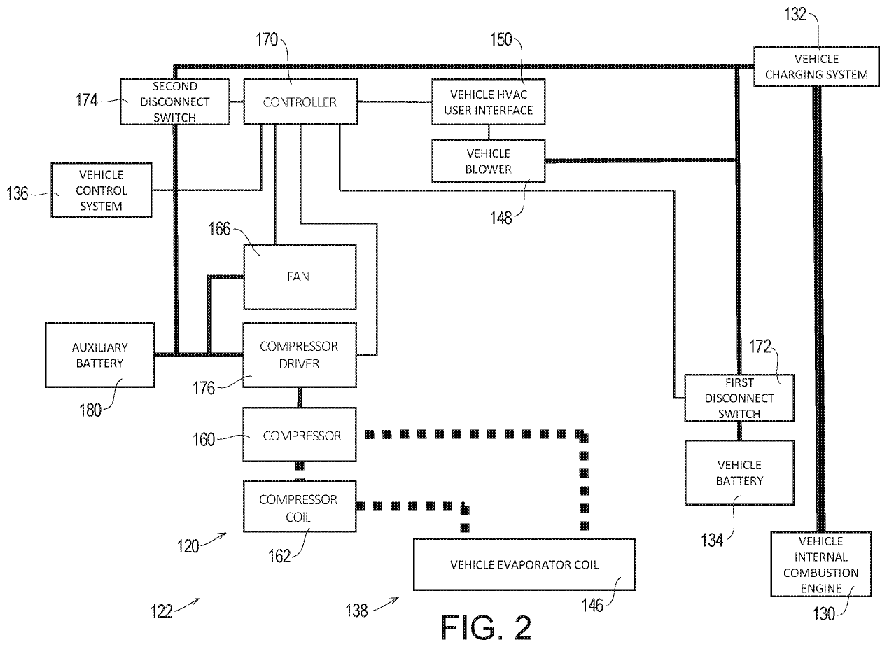

Referring now to FIG. 2 of the drawing, depicted therein is a second example auxiliary vehicle heating and cooling system 120 of the present invention. As will be described in further detail below, the second example vehicle heating and cooling system 120 is intended to augment a factory vehicle heating and cooling system.

The second example vehicle heating and cooling system 120 is configured to be used in conjunction with a vehicle 122. In this application, the term “vehicle” refers to a movable structure (whether moving or stationary) having an internal combustion engine that drives an alternator to provide DC power to an on board electronics systems. Examples of vehicles include trucks, automobiles, shipping containers, and boats.

The example vehicle 122 is or may be conventional and comprises an internal combustion engine 130, a vehicle charging system 132, a vehicle battery 134, a vehicle control system 136, and a vehicle HVAC system 138. The example internal combustion system 130, vehicle charging system 132, vehicle battery 134, and vehicle control system 136 are or may be conventional and will not be described herein beyond what is helpful for a complete understanding of the present invention.

The example vehicle HVAC system 138 comprises a vehicle evaporator coil 144. The vehicle evaporator coil 144 is arranged to exchange heat with air within the AC region, and a vehicle blower 148 is associated with the vehicle evaporator coil 144.

The example vehicle HVAC system 138 further comprises a vehicle HVAC user interface 150 arranged to allow an occupant of the AC region to control the vehicle HVAC system 138. The example HVAC user interface 150 may be implemented using mechanical or electromechanical interface objects such as switches, buttons, sliders, or the like and/or by electronic interface objects such as switches, buttons, touch screens or the like. The example HVAC user interface system 150 may be implemented with or without a thermostat capable of detecting temperature within the AC region and controlling operation of the various components of the vehicle HVAC system 138 to maintain temperature within the AC region based on a desired temperature.

The second example HVAC system 120 is configured to integrate with at least a portion of the vehicle HVAC system 138 and comprises a compressor 160 and a compressor coil 162 connected to the vehicle evaporator coil 144 to form a heat pump. The compressor coil 162 is arranged to exchange heat with ambient air outside of the AC region, and a fan 166 is associated with the example compressor coil 162.

The example HVAC system 120 further comprises a controller 170, a first disconnect switch 172, and a second disconnect switch 174. The example controller 170 is arranged to control the components of the HVAC system 120 based on control settings of the vehicle HVAC user interface 150. Optionally, an compressor driver 176 may be used to facilitate operation of the compressor 160 by the controller 170.

The example HVAC system 120 further comprises an auxiliary battery system 180 comprising one or more batteries and associated circuitry and wiring.

The example HVAC system 120 operates in at least one of a vehicle mode and an auxiliary mode as determined by the vehicle control system 136.

In the vehicle mode, the second disconnect switch 174 is closed to allow the vehicle charging system 132 to charge the auxiliary battery 180.

In the auxiliary mode, the first disconnect switch 172 is opened to prevent power from flowing from the vehicle battery 134 to the HVAC system 120. When the HVAC system 120 is in the auxiliary mode, the compressor 160 and compressor coil 162 are connected to the vehicle evaporator coil 144, and the AC region is heated and cooled using the HVAC system 120. The second disconnect switch 174 is opened to disconnect the auxiliary battery 180 from the vehicle charging system 132 and vehicle battery 134 to prevent draining of the vehicle battery 134 in the auxiliary mode.

In the auxiliary mode, the controller 170 controls the compressor 160 through the compressor driver 176, the fan 166 based on user inputs to the vehicle HVAC user interface 150. The controller 170 converts signals generated by the HVAC user interface 150 into control signals appropriate for the components of the HVAC system 120. The controller 170 may further comprise an on/off switch accessible by the user and one or more of a temperature sensor and a pressure sensor capable of sensing temperatures (e.g., temperature of AC region) and pressures (e.g., pressure within HVAC system 120) necessary to ensure proper operation of the HVAC system 120.

What is claimed is:

1. A vehicle heating and cooling system comprising:
at least one battery;
a vehicle evaporator coil;
a vehicle HVAC user interface;
a vehicle compressor;
an auxiliary compressor;
a vehicle compressor coil;
an auxiliary compressor coil;
an auxiliary control valve array configured to operate in vehicle and auxiliary modes, where
in the vehicle mode, the vehicle compressor is operatively connected to the vehicle evaporator coil and to the vehicle compressor coil and the auxiliary compressor and the auxiliary compressor coil are disconnected from the vehicle evaporator coil, and
in the auxiliary mode, the vehicle compressor and vehicle compressor coil are disconnected from the vehicle evaporator coil and the auxiliary compressor is operatively connected to the vehicle evaporator coil and to the auxiliary compressor coil; and
a controller for selectively controlling the auxiliary control valve array to operate in one of
the vehicle mode and the auxiliary mode; wherein
the auxiliary compressor is operatively connected to the at least one battery.

2. The vehicle heating and cooling system as recited in claim 1, further comprising a vehicle internal combustion engine, where the auxiliary compressor is not mechanically connected to the vehicle internal combustion engine.

3. The vehicle heating and cooling system as recited in claim 1, in which the at least one battery comprises a vehicle battery, the system further comprising a control system configured to operatively connect the vehicle battery to at least one of the vehicle compressor and the auxiliary compressor.

4. The vehicle heating and cooling system as recited in claim 1, in which the at least one battery comprises an auxiliary battery, the system further comprising a control system configured to operatively connect the auxiliary battery to at least one of the vehicle compressor and the auxiliary compressor.

5. The vehicle heating and cooling system as recited in claim 1, in which the at least one battery comprises a vehicle battery and an auxiliary battery, the system further comprising a control system configured to operatively connect at least one of the vehicle battery and the auxiliary battery to the auxiliary compressor or the vehicle compressor.

6. The vehicle heating and cooling system as recited in claim 5, in which the control system comprises a disconnect switch configured to disconnect the vehicle battery from the auxiliary battery.

7. The vehicle heating and cooling system as recited in claim 3, in which:
the vehicle heating and cooling system further comprises a vehicle charging system operatively connected to a vehicle internal combustion engine; and
the vehicle battery is operably connected to the vehicle charging system.

8. The vehicle heating and cooling system as recited in claim 4, in which:
the vehicle heating and cooling system further comprises a vehicle charging system operatively connected to a vehicle internal combustion engine; and
the auxiliary battery is operably connected to the vehicle charging system.

9. The vehicle heating and cooling system as recited in claim 5, in which:
the vehicle heating and cooling system further comprises a vehicle charging system operatively connected to a vehicle internal combustion engine; and
the vehicle battery and auxiliary battery are operably connected to the vehicle charging system.

10. The vehicle heating and cooling system as recited in claim 9, further comprising:
a first disconnect switch configured to disconnect the vehicle battery from the compressor; and
a second disconnect switch configured to disconnect the auxiliary battery from the compressor.

11. A method of heating and cooling a vehicle comprising the steps of:
providing a vehicle evaporator coil;
providing a vehicle HVAC user interface;
providing a vehicle compressor;
providing an auxiliary compressor;
providing a vehicle compressor coil;
providing an auxiliary compressor coil;
providing at least one battery;
arranging an auxiliary control valve array to operate in a vehicle mode and in an auxiliary mode, where
in the vehicle mode, the vehicle compressor is operatively connected to the vehicle evaporator coil and to the vehicle compressor coil and the auxiliary compressor and the auxiliary compressor coil are disconnected from the vehicle evaporator coil, and
in the auxiliary mode, the vehicle compressor and vehicle compressor coil are disconnected from the vehicle evaporator coil and the auxiliary compressor is operatively connected to the vehicle evaporator coil and to the auxiliary compressor coil;
selectively controlling the auxiliary control valve array to operate in one of the vehicle mode and the auxiliary mode; and
operatively connecting the auxiliary compressor to the at least one battery.

12. The method as recited in claim 11, further comprising the step of operatively connecting the auxiliary compressor to the at least one battery such that the auxiliary compressor is not mechanically connected to the vehicle internal combustion engine.

13. The method as recited in claim 11, in which the step of providing at least one battery further comprises the step of providing a vehicle battery configured to be operatively connected to a vehicle internal combustion engine of the vehicle for charging.

14. The method as recited in claim 11, in which the step of providing at least one battery further comprises the step of providing an auxiliary battery.

15. The method as recited in claim 11, in which the step of providing at least one battery further comprises the step of providing a vehicle battery and an auxiliary battery, where the vehicle battery and the auxiliary battery are configured to be operatively connected to a vehicle internal combustion engine of the vehicle for charging.

16. The method as recited in claim 15, further comprising the steps of:
operably connecting a vehicle charging system to a vehicle internal combustion engine; and
operably connecting the auxiliary battery to the vehicle charging system.
